(19) United States
(12) Patent Application Publication
(10) Pub. No.: US 2008/0186419 A1
(43) Pub. Date: Aug. 7, 2008

(54) PLASMA DISPLAY DEVICE

(76) Inventors: Dong Hyun Kim, Suwon (KR); Young Soo Seo, Suwon (KR); Jung Suk Song, Suwon (KR); Jun Tae Kim, Suwon (KR); Jeong Min Choi, Suwon (KR)

Correspondence Address: CHRISTIE, PARKER & HALE, LLP, PO BOX 7068, PASADENA, CA, 91109-7068, US

(21) Appl. No.: 11/836,049

(22) Filed: Aug. 8, 2007

(30) Foreign Application Priority Data
Feb. 7, 2007 (KR) 10-2007-0012867

(51) Int. Cl. G02F 1/133; H01J 9/00

(52) U.S. Cl. 349/32; 445/24

(57) ABSTRACT

A plasma display device is provided having a plasma display panel, a chassis base arranged substantially parallel to the plasma display panel, a tape bonding the plasma display panel to the chassis base, and a radiative sheet interposed between and adhering to the plasma display panel and the chassis base. The radiative sheet is of material having a layered crystal structure. The layered crystal structure is arranged to extend at an angle from the plasma display panel. The angle is not horizontal/parallel to a surface of the plasma display panel.

### CROSS-REFERENCE TO RELATED APPLICATIONS

This application claims priority to and the benefit of Korean Patent Application No. 10-2007-0012867, filed on Feb. 7, 2007, in the Korean Intellectual Property Office, the entire content of which is incorporated herein by reference.

### BACKGROUND

1. Field of the Invention

The present invention relates to a plasma display device, and more particularly to a plasma display device having a radiative sheet for heat radiation between the plasma display panel and a chassis unit attached thereto.

2. Discussion of Related Art

A plasma display device is a device for displaying an image on a plasma display panel (PDP) by using plasma generated by means of gas discharge. The gas discharge generates significant heat in the PDP due to the high temperature of the discharge gas.

Furthermore, if the brightness of the PDP is increased, the heat generated in the PDP increases such that the heat leaves an after image on the display and can decrease the life span of the plasma display device. Therefore, efficiently discharging heat from the plasma display device is important so that the device can operate smoothly.

For this reason, in many conventional plasma display devices the PDP is attached to a chassis base comprised of material having excellent heat conductivity with a radiative sheet (or a heat conduction sheet) interposed between the PDP and the chassis base such that the heat generated in the PDP is conducted through the radiative sheet and the chassis base, therefore making it possible to discharge heat out of the device. The chassis base is manufactured through a die casting or a press with metal materials such as aluminum, or the like, and the radiative sheet is comprised of acrylic-based and silicon-based resins, or the like.

In order to improve the heat radiation efficiency of the radiative sheet, various attempts have been made. For example, Korean Patent Publication No. 10-2005-0000136 discloses a plasma display device with a radiative sheet having improved radiation efficiency. The conventional radiative sheet acts as a heat sink comprised of a composite radiative sheet having an anisotropic heat conductivity in a planar direction.

In the case of a graphite radiative sheet, the arrangement of carbon is in a layered structure in which electrons can freely move within the layer between the carbon atoms such that there is high electrical conductivity within the layer. The distance between the layers is relatively spaced such that coupling is weak and the electrons cannot freely move across layers. As a result, there is less electrical conductivity across layers.

Accordingly, the conventional radiative sheet has high heat conductivity in a planar direction. That is, the conventional radiative sheet has a layered structure arranged to be parallel to a panel surface, thus heat radiation of the radiative sheet is mainly generated through only a lateral surface having a small cross-section. The conventional radiative sheet therefore has an inefficient heat radiation structure such that the moving path of the heat is lengthened and the area of heat radiation is small.

Therefore, a radiative sheet is needed that shortens the moving path of the heat and maximizes the heat radiation area.

### SUMMARY OF THE INVENTION

A plasma display device is provided with a radiative sheet in which a layered crystal structure is arranged to be vertical or oblique to a surface of a PDP. The layered crystal structure is based on hexagonal covalent bonds.

A plasma display device is provided having a PDP, a chassis base arranged substantially parallel to the PDP, a tape bonding the PDP to the chassis base, and a radiative sheet interposed between and adhered to the PDP and the chassis base.

The radiative sheet is made of material having a layered crystal structure. The layered crystal structure extends at an angle from the PDP. The angle is greater than 0° from a surface of the PDP.

In an exemplary embodiment of the present invention, the crystal structure of the radiative sheet may be arranged to be substantially vertical/perpendicular or to be oblique to a surface of the PDP.

In another exemplary embodiment, the radiative sheet is of a graphite material.

In addition, a method of arranging a radiative sheet in a plasma display device is provided. The radiative sheet has a layered crystal structure. The plasma display device has a plasma display panel extending in a first plane. The method includes arranging the radiative sheet adjacent to the plasma display panel such that the radiative sheet extends substantially parallel to the first plane and the layered crystal structure extends in a second plane crossing the first plane.

In an exemplary embodiment of the present invention, the radiative sheet is of a graphite material.

In an exemplary embodiment of the present invention, the second plane extends at an angle θ from the first plane and θ satisfies the equation 0°<θ<180°.

In an exemplary embodiment of the present invention, the radiative sheet is arranged such that heat conductivity in a thickness direction of the plasma display panel is greater than in a planar direction with the second plane extending at an angle θ from the first plane and θ satisfying the equation 45°<θ<135°.

In an exemplary embodiment of the present invention, the angle θ is approximately equal to 90°.

### BRIEF DESCRIPTION OF THE DRAWINGS

FIG. 1 is a partially exploded perspective view showing a plasma display device of an embodiment of the present invention.

FIG. 2 is a lateral view showing the plasma display device as shown in FIG. 1.

FIG. 3 is a schematic depiction of a crystal structure of graphite.

FIG. 4 is a schematic depiction of heat radiation by a radiative sheet having a horizontal layered structure for heat radiation.

FIG. 5 is a schematic depiction of heat radiation by a radiative sheet according to a first embodiment of the present invention.

FIG. 6 is a schematic depiction of heat radiation by a radiative sheet according to a second embodiment of the present invention.

FIG. 7 is a graph comparing the increase of temperature of a PDP having a conventional radiative sheet and a PDP having a radiative sheet of an embodiment of the present invention.

### DETAILED DESCRIPTION

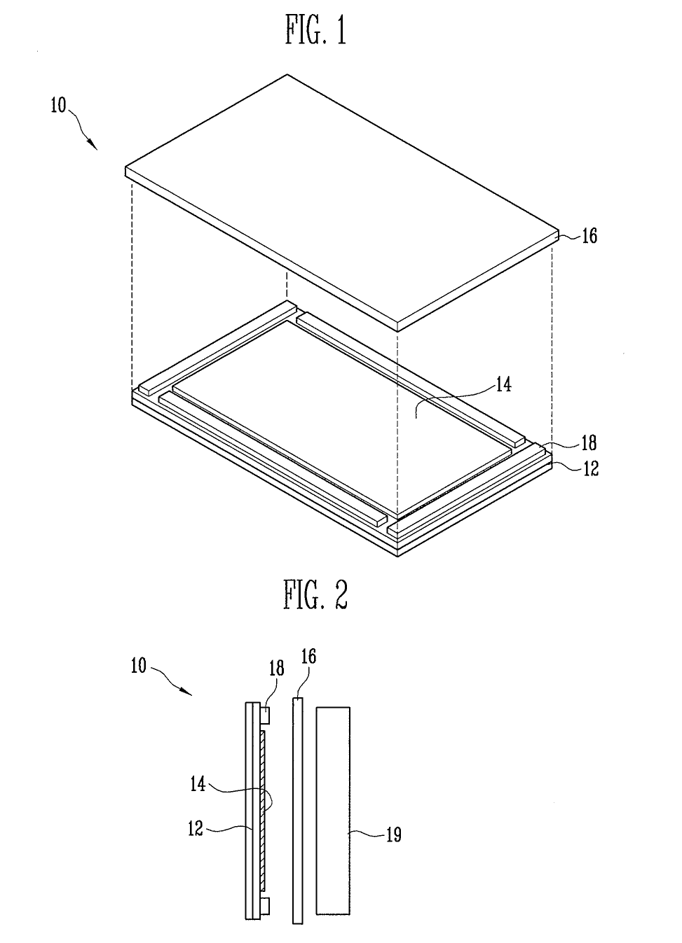

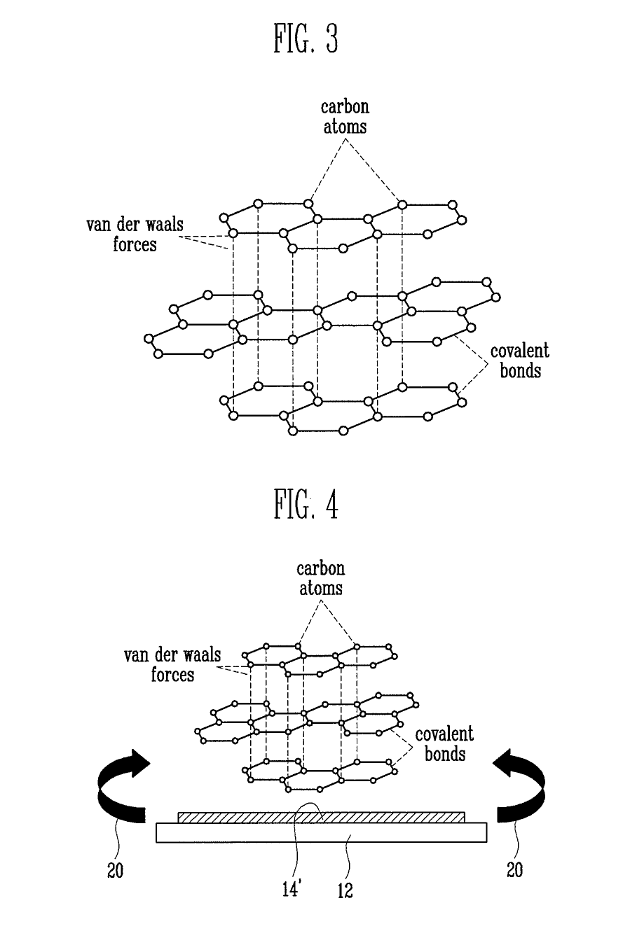

Referring to FIG. 1 and FIG. 2, a plasma display device 10 according to an embodiment of the present invention includes a PDP 12 and a chassis base 16. One side surface of the chassis base 16 is mounted with the PDP 12 and the other side surface thereof is mounted with a driving circuit unit 19 for driving the PDP 12.

The chassis base 16 is disposed to be substantially parallel to the PDP 12, and a radiative sheet 14 is interposed therebetween to be closely adhered to the chassis base 16 and the PDP 12, acting to radiate and disperse the heat generated from the PDP 12. Attachment tape 18 is used for bonding the PDP 12 to the chassis base 16. A front surface cover (not shown) is positioned on the outer side of the PDP 12. A rear surface cover (not shown) is positioned on the outer side of the chassis base 16. Both the front surface cover and the rear surface cover are coupled together.

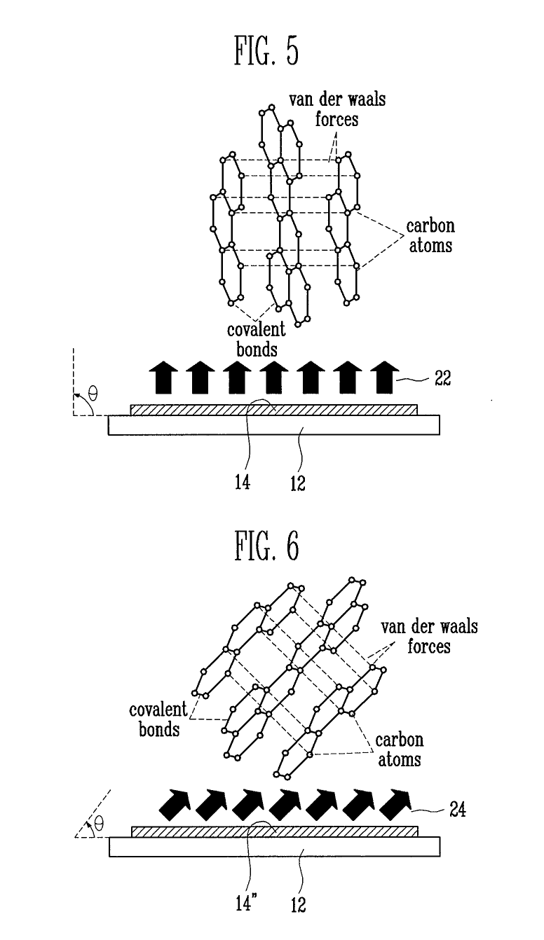

Referring now to FIG. 3 and FIG. 4, the conventional radiative sheet 14′ is made of graphite having a layered structure based on hexagonal covalent bonds and intermolecular forces such as van der Waals forces. The conventional radiative sheet 14′ is placed in a direction to be horizontal to the PDP 12 such that a crystal structure of the radiative sheet 14′ has anisotropic heat conductivity in a planar direction. In such an arrangement, the heat radiation is mainly generated through only a lateral surface having a small cross-section and the moving path (shown by arrows 20) of the heat is lengthened. In such an arrangement, heat radiation is not optimized.

FIG. 5 is a schematic depiction of heat radiation by a radiative sheet according to a first embodiment of the present invention. As depicted in FIG. 5, the angle θ of the crystal structure of the radiative sheet 14 is vertical/perpendicular to the surface of panel 12.

The radiative sheet of an embodiment of the present invention is made of graphite having a layered structure based on hexagonal covalent bonds, however the radiative sheet is arranged to have an angle θ not horizontal/parallel to the surface of the panel 12, such that the graphite has anisotropic heat conductivity greater in a thickness direction than in a planar direction.

Herein, in an embodiment of the present invention, graphite having a layered structure based on hexagonal covalent bonds is described, by way of example, as the radiative sheet 14. However, any materials having a layered crystal structure other than graphite may be applied. The focus of embodiments of the present invention is directed to a PDP having a radiative sheet whose layered crystal structure has a direction not horizontal/parallel to the surface of the panel 12.

The radiative sheet 14 according to an embodiment of the present invention when the angle θ is approximately equal to 90° has anisotropic heat conductivity greater in a thickness direction than in a planar direction such that heat radiation is mainly generated through an upper surface having a large cross section, which widens the area of heat radiation and shortens the moving path of heat (shown by arrows 22).

Specifically, experimental results on heat conductivity between a conventional radiative sheet 14′ having a crystal structure extending in a horizontal direction and the radiative sheet 14 according to an exemplary embodiment of the present invention having a crystal structure extending in a vertical direction follows.

### EXPERIMENT EXAMPLE

Measurement results of the temperature of panels having graphite radiative sheets with either horizontal (prior art) or vertical crystal structure alignments are provided. The measurement results were recorded between 0 minutes and 30 minutes while driving the respective devices. The measurement results are shown in Table 1 and the results are plotted in FIG. 7.

In FIG. 7, the black points represent the temperature of a panel of the conventional radiative sheet with crystal structure in a horizontal direction and the white points represent the temperature of a panel of the radiative sheet of an embodiment of the present invention with a crystal structure in a vertical direction.

When the radiative sheet having a crystal structure in a horizontal direction is used in the plasma display device, the temperature of the panel is 47° C. after driving the PDP for 30 minutes, whereas when the radiative sheet having a crystal structure in a vertical direction is used in the plasma display device, the temperature of the panel is 40° C. after driving the PDP for 30 minutes. Therefore, it can be appreciated that the heat radiation is better when a radiative sheet having a vertical crystal structure is used in the plasma display device. Table 1 also depicts below this comparison:

TABLE 1
Temperature of panel according to sorts of radiative sheets

| | Radiative sheets in a | Radiative sheets in a |
|---|---|---|
| | horizontal direction | vertical direction |
| | θ = 0° | θ = 90° |
| Temperature of panel | 47° C. | 40° C. |
| after 30 minutes | | |

The radiative sheet 14 helps to prevent an after image on a display and to prevent a decrease in the life span of the plasma display device due to heat generated at the time of discharge of the PDP 12. Therefore, embodiments of the present invention can efficiently radiate heat generated in the plasma display device by using the radiative sheet 14 made of graphite having excellent heat conductivity on the rear surface of the panel.

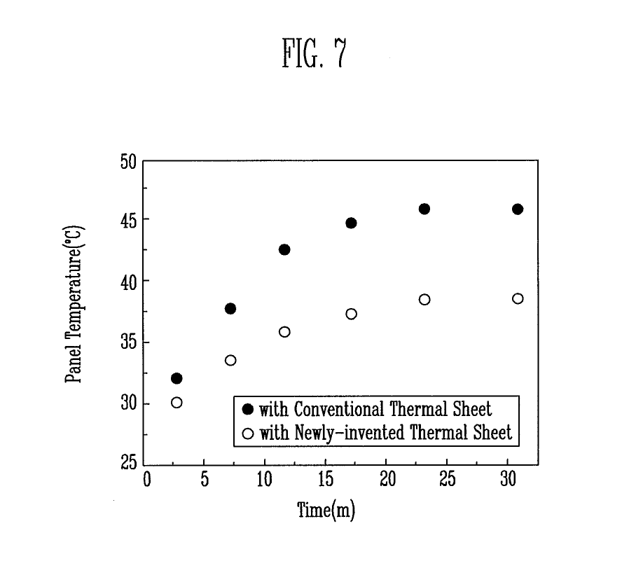

FIG. 6 is a schematic depiction of heat radiation by a radiative sheet according to a second embodiment of the present invention. The radiative sheet 14″ according to the second embodiment of the present invention has a layered structure based on hexagonal covalent bonds. The radiative sheet 14″ has a crystal structure arranged to be at an angle θ oblique to the surface of the panel 12.

Herein, an oblique crystalline structure is an arrangement that includes all angles between a vertical angle and a horizontal angle. In other words, the radiative sheet 14 having a crystal structure extending in a vertical direction to the panel 12 has an angle 90° from the panel 12 (the first embodiment of the present invention), and the radiative sheet 14″ having a crystal structure extending in an oblique direction to the panel 12 has an angle between 0° and 90° from the panel 12 (the second embodiment of the present invention).

As described above, even when a crystal structure of the radiative sheet 14″ is arranged to be oblique to the panel 12, the radiative sheet 14″ shortens the moving path of heat and maximizes the area of heat radiation in comparison to the radiative sheet having the horizontal layered crystal structure.

Therefore, as in the first embodiment of the present invention, the second embodiment of the present invention acts to prevent an after image on a display and to prevent reduction of life span of the plasma display device.

As described above, with the plasma display device having the radiative sheet according to embodiments of the present invention, the radiative sheet has a layered crystal structure oriented greater than 0° from the panel 12, which extends in a horizontal direction, and less than or equal to 90° from the panel 12, 90° being an angle such that the radiative sheet has crystal structure extending perpendicular to the panel 12. When the radiative sheet has crystal structure oriented between 45° and 90° from the panel 12, the anisotropic heat conductivity is greater in a thickness/vertical direction than that in a plane/horizontal direction.

Thus, as depicted in FIG. 6, according to exemplary embodiments of the present invention, θ satisfies the following equation 0<θ<180°, and when θ satisfies the equation 45°<θ<135°, the anisotropic heat conductivity is greater in a thickness direction than in a planar direction.

The radiative sheet according to embodiments of the present invention prevents the concentration of heat by shortening the moving path of heat and maximizing the area of heat radiation. Thus, the radiative sheet according to exemplary embodiments of the present invention more effectively discharges heat generated by the PDP, which improves the operating characteristics of the plasma display device.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display device including:
a plasma display panel;
a chassis base arranged substantially parallel to the plasma display panel;
a tape bonding the plasma display panel to the chassis base; and
a radiative sheet interposed between and adhering to the plasma display panel and the chassis base,
wherein the radiative sheet is of a material having a layered crystal structure, the layered crystal structure being arranged to extend at an angle from the plasma display panel, the angle being greater than 0° from a surface of the plasma display panel.

2. The plasma display device as claimed in claim 1, wherein the crystal structure of the radiative sheet is arranged to be substantially perpendicular to the panel surface.

3. The plasma display device as claimed in claim 1, wherein the crystal structure of the radiative sheet is arranged to be oblique to the panel surface.

4. The plasma display device as claimed in claim 1, wherein the radiative sheet is of a graphite material.

5. A plasma display device including:
a plasma display panel extending in a first direction;
a chassis base arranged substantially parallel to the plasma display panel; and
a radiative sheet extending in the first direction and interposed between the plasma display panel and the chassis base, the radiative sheet having a layered crystal structure extending in a second direction;
wherein an angle θ between the first direction and the second direction satisfies the equation 0°<θ<180°.

6. The plasma display device as claimed in claim 5, wherein the radiative sheet is of a graphite material.

7. The plasma display device as claimed in claim 5, wherein the angle θ satisfies the equation 45°<θ<135° such that heat conductivity in a thickness direction of the plasma display panel is greater than in a planar direction of the plasma display panel.

8. The plasma display device as claimed in claim 7, wherein the angle θ is approximately equal to 90°.

9. A method of arranging a radiative sheet in a plasma display device, the radiative sheet having a layered crystal structure, the plasma display device having a plasma display panel extending in a first plane, the method comprising:
arranging the radiative sheet adjacent to the plasma display panel such that the radiative sheet extends substantially parallel to the first plane and the layered crystal structure extends in a second plane crossing the first plane.

10. The method as claimed in claim 9, wherein the radiative sheet is of a graphite material.

11. The method as claimed in claim 9, wherein the second plane extends at an angle θ from the first plane and θ satisfies the equation 0°<θ<180°.

12. The method as claimed in claim 9, wherein the radiative sheet is arranged such that heat conductivity in a thickness direction of the plasma display panel is greater than in a planar direction with the second plane extending at an angle θ from the first plane and θ satisfying the equation 45°<θ<135°.

13. The method as claimed in claim 12, wherein the angle θ is approximately equal to 90°.
